(19) United States
(12) Patent Application Publication
(10) Pub. No.: US 2008/0284771 A1
(43) Pub. Date: Nov. 20, 2008

(54) DISPLAY DEVICE AND PRE-CHARGING CIRCUIT

(75) Inventor: Fumirou Matsuki, Kobe (JP)

Correspondence Address: VENABLE LLP, P.O. BOX 34385, WASHINGTON, DC, 20043-9998, US

(73) Assignee: TPO Displays Corp., ChuNan (TW)

(21) Appl. No.: 12/098,756

(22) Filed: Apr. 7, 2008

(30) Foreign Application Priority Data
May 14, 2007 (JP) 2007-127799

(51) Int. Cl. G06F 3/038

(52) U.S. Cl. 345/211

(57) ABSTRACT

The present invention is to provide a display device having a pre-charge circuit that is simple in construction by eliminating the need for a pre-charge power supply. A pre-charge circuit pre-charges the plurality of source buses prior to driving a plurality of source buses by a source driver. In the pre-charge circuit, pre-charge lines are connected to the plurality of source buses at the time of pre-charging. Pre-charge control switches connect pre-charge capacitors alternately to power supplies or the pre-charge lines. The pre-charge capacitors are charged when connected to the power supplies. The pre-charge capacitors are used to pre-charge the plurality of source buses when connected to the pre-charge lines.

### BACKGROUND OF THE INVENTION

1. Field of the Invention

The present invention relates to a display device provided with a pre-charge circuit connected to a source bus.

2. Description of the Related Art

In a liquid crystal display device, there are a large number of source buses that are connected to a source driver. And a data signal corresponding to an image to be displayed is supplied from the source driver to a large number of pixels in a display area by way of the source buses.

Conventionally, a pre-charge circuit is used in such display device. The pre-charge circuit is designed to perform pre-charging the source buses at a timing prior to supplying the data signal. A pre-charge voltage is set to an intermediate value lower than the voltage of the data signal.

FIG. 1 shows a display device including a conventional pre-charge circuit. A display device 101 comprises a plurality of source buses 103, a source driver 105 and a pre-charge circuit 107.

The plurality of source buses 103 extend to a display area of a liquid crystal display panel and a large number of pixels are disposed along each source bus 103. The source driver 105 is connected to a pair of voltage sources 109a and 109b of opposite polarity to each other. In this arrangement, the source driver 105 supplies to the plurality of source buses 103 the data signal that alternately inverts in polarity, thereby performing a dot inversion.

In the pre-charge circuit 107, a pair of pre-charge lines 111a, 111b are alternately connected to the plurality of source buses 103 by way of switches SW1, SW2 as shown in FIG. 1. The pre-charge lines 111a, 111b are connected to a pair of pre-charge voltage sources 113a, 113b that are opposite in polarity to each other. The voltage of the pre-charge voltage sources 113a, 113b is set to an intermediate value that is lower than that of the voltage sources 109a, 109b in the source driver 105. This voltage is equal to the pre-charge voltage. In the shown example, the voltages of the pre-charge voltage sources 113a, 113b are 2.5V and −2.5V, while the voltages VDD1, VDD2 of the voltage sources 109a, 109b are 5V and −5V.

The pre-charge circuit 107 operates to apply the pre-charge voltages to the plurality of source buses 103 for pre-charging by opening and closing the switches SW1, SW2. Pre-charging is performed before supplying the data signal from the source driver 105. The switches SW1, SW2 are switched ON/OFF whenever a new row (gate lines) is addressed. That is, the first switch SW1 is ON for one row, while the second switch SW2 is ON for the next row. This means that the polarity of the pre-charge voltage changes for every source bus and every row, thereby pre-charging in response to the dot inversion.

A conventional display device 101 having a typical pre-charge circuit 107 has been described hereinabove. As apparent from the above description, in the conventional display device, the pre-charge circuit 107 is provided with exclusive pre-charge voltage sources 113a, 113b. Accordingly, it has such problems as making a power supply system complicated and larger in size.

There is another prior art (See the Patent Document 1 below), wherein a pre-charge circuit is realized by a unit pre-charge circuit for each source bus and the unit pre-charge bus comprises a capacitor and four switches that are connected to a common electrode for supplying a reference voltage. Although no pre-charge voltage source may be excluded in this case, it is necessary to provide a capacitor and the like for each source bus, thereby making the construction complicated.

[Patent Document 1] Japanese patent publication no. 2005-31202

### SUMMARY OF THE INVENTION

The present invention is made in consideration of solving the above problems and its object is to provide a display device having a less complicated pre-charge circuit that requires an additional pre-charge power supply.

The another object of the present invention to provide a display device that requires no pre-charge power supply and improves accuracy of the pre-charge voltage.

To achieve the above-described object, one embodiment of the present invention provides a display device that comprises a plurality of source buses, a source driver connected to the plurality of source buses, at least one power supply for supplying electric power to the plurality of source buses and a pre-charge circuit for pre-charging the plurality of source buses, wherein the pre-charge circuit comprises at least one pre-charge line that is connected to the plurality of source buses when pre-charging, at least one pre-charge capacitor, and at least one pre-charge control switch for alternately connecting the at least one pre-charge capacitor to the at least one power supply and the at least one pre-charge line.

The at least one pre-charge control circuit may connect the at least one pre-charge capacitor to the at least one power supply for charging the at least one pre-charge capacitor and may connect the charged at least one pre-charge capacitor to the at least one pre-charge line for pre-charging the plurality of source buses.

The display device may have first and second power supplies for inversion driving as the at least one power supply, the pre-charge circuit may have first and second pre-charge lines as the at least one pre-charge line, first and second pre-charge capacitors as the at least one pre-charge capacitor, and first and second pre-charge control switches as the at least one pre-charge control switch, wherein the first and second pre-charge control switches may alternately connect the first and second pre-charge capacitors to the first and second power supplies and the first and second pre-charge lines.

In another embodiment of the present invention, a pre-charge circuit for pre-charging the plurality of source buses is provided in a display device comprising a plurality of source buses, a source driver to be connected to the plurality of source buses and at least one power supply, wherein the pre-charge circuit is for supplying electrical power to the plurality of source buses and comprises at least one pre-charge line to be connected to the plurality of source buses at the time of pre-charging, at least one pre-charge capacitor and at least one pre-charge control switch for alternately connecting the at least one pre-charge capacitor to the at least one power supply and the at least one pre-charge line.

Another embodiment of the present invention is an electronic apparatus having the abovementioned display device, wherein the electronic apparatus is selected from a group of a mobile phone, a digital camera, a personal digital assistant (PDA), a notebook computer, a desktop computer, a television, a car media player, a portable video player, a GPS device, an avionics display or a digital photo frame.

Since the pre-charge circuit of the present invention comprises the pre-charge capacitor and the pre-charge control switch, the pre-charge capacitor is pre-charged by using the power supply in the source driver and the charged pre-charged capacitor is used for pre-charging the plurality of pre-charge capacitor. In this way, an additional pre-charge power supply is eliminated for providing the display device having the pre-charge circuit of simple construction.

### BRIEF DESCRIPTION OF THE DRAWINGS

FIG. 1 is a schematic to show a conventional display device.

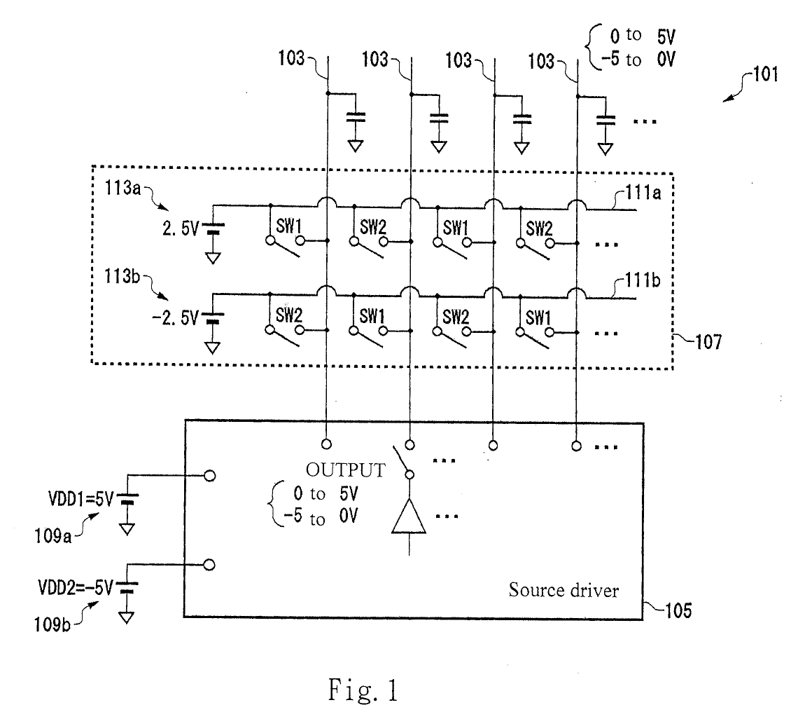

FIG. 2 is a schematic to show a first embodiment of the display device.

FIG. 3 is a schematic to describe the operation of the first embodiment of the display device.

FIG. 4 shows the pre-charge circuit prior to pre-charge.

FIG. 5 shows the pre-charge circuit in the pre-charge state in the pre-charge period.

FIG. 6 is a second embodiment of the display device.

FIG. 7 is a schematic to describe the operation of the second embodiment of the display device.

FIG. 8 shows the pre-charge circuit prior to pre-charge.

FIG. 9 shows the pre-charge circuit when the source buses are discharged in a first pre-charge period.

FIG. 10 shows the pre-charge circuit in the pre-charge state in a second pre-charge period.

### DETAILED DESCRIPTION OF THE PREFERRED EMBODIMENTS

Now, the present invention will be described in detail hereunder. It is to be noted, however, that the following detailed description and the accompanying drawings are not for restricting the invention. Instead, the scope of the present invention should be defined by the claim for patent.

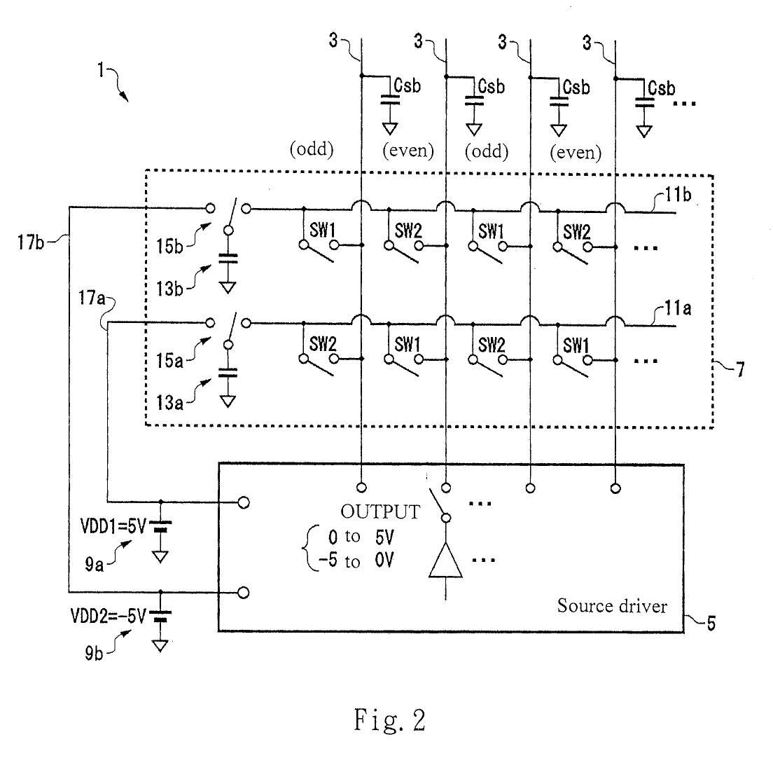

FIG. 2 shows a first embodiment of the display device. The display device 1 comprises a plurality of source buses 3, a source driver 5 and a pre-charge circuit 7.

The plurality of source buses 3 extend to the display area of a liquid crystal panel and there are a large number of pixels disposed along each of the source buses 3. It is considered that a capacitor corresponding to one of the plurality of pixels in the display area is connected to each source bus 3. The capacitance of such capacitor is referred to a source bus Csb.

The source driver 5 is a circuit for supplying to the plurality of source buses 3 the data signal in response to an image to be displayed under control of a host control circuit (not shown). The display device 1 further comprises a gate driver (not shown) for driving a plurality of gate lines in the display area. The gate lines and source buses are crossed in the display area to provide a large number of pixels disposed in matrix. The gate lines are sequentially driven by the gate driver and also the source buses 3 are driven by the source driver 5 for displaying the image.

The source driver 5 is connected to a pair of power supplies (voltage sources) 9a, 9b of opposite polarity to each other. The source driver 5 utilizes the electrical power to be supplied from the power supplies 9a, 9b to supplies to the plurality of source buses 3 the data signals that alternately change the polarity, thereby performing dot inversion driving. In the shown example, the voltages VDD1, VDD2 of power supplies 9a, 9b are respectively 5V, −5V. A data signal in the range of 0˜5V and a signal in the range of −5˜0V are alternately inputted to each source bus.

The pre-charge circuit 7 is disposed at the output side of the source driver 5. The pre-charge circuit 7 is shown at a location outside the source driver 5. However, in an actual circuit arrangement, it comprises a wiring, a capacitor and a switch that are included in the source driver 5 as an integral part thereof.

The pre-charge circuit 7 has a pair of pre-charge lines 11a, 11b, a pair of pre-charge capacitors 13a, 13b and a pair of pre-charge control switches 15a, 15b that use the pre-charge capacitors 13a, 13b for controlling the pre-charge.

The pre-charge lines 11a are 11b are referred to as a first pre-charge line 11a and a second pre-charge line 11b hereinafter. The pre-charge capacitors 13a and 13b are referred to as a first pre-charge capacitor 13a and a second pre-charge capacitor 13b. Similarly, the pre-charge control switches 15a and 15b are referred to as a first pre-charge control switch 15a and a second pre-charge control switch 15b.

The pre-charge lines 11a, 11b are connected to the plurality of source buses 3 by way of the switches SW1, SW2. These switches SW1, SW2 correspond to the line switches in the present invention. As shown in FIG. 2, the pre-charge lines 11a, 11b are alternately connected to the plurality of source buses 3 by way of the switches SW1, SW2. Also, the pre-charge lines 11a, 11b are connected to each source bus 3 by way of different switches SW1, SW2. The switches SW1 and SW2 are referred to as a first switch SW1 and a second switch SW2 hereunder, respectively.

Describing more in detail, as shown in FIG. 2, the first pre-charge line 11a is connected to the odd column source buses 3 by way of the second switch SW2, while connecting it to even column source buses 3 by way of the first switch SW1. On the other hand, the second pre-charge line 11b is connected to the odd column source buses 3 by way of a first switch SW1, while connecting it to the even column source buses 3 by way of the second switch SW2. This achieves the aforementioned alternate connection.

The pre-charge control switches 15a, 15b selectively connect the pre-charge capacitors 13a, 13b to the power supplies 9a, 9b and the pre-charge lines 11a, 11b. By connecting the pre-charge capacitors 13a, 13b and the power supplies 9a, 9b, the pre-charge capacitors 13a, 13b are charged. On the other hand, by connecting the pre-charge capacitors 13a, 13b and the pre-charge lines 11a, 11b, charges charged in the pre-charge capacitors 13a, 13b are supplied to the pre-charge lines 11a, 11b. These connections are made alternately as described hereinafter.

Now, construction associated with the aforementioned pre-charge control switches 15a, 15b will be described in detail. The pre-charge circuit 7 is connected to the power supplies 9a, 9b for the source driver 5 by way of lines 17a, 17b.

One electrode of the first pre-charge capacitor 13a is connected to ground. The other electrode of the first pre-charge capacitor 13a is connected to either the line 17a or the first pre-charge line 11a by the first pre-charge control switch 15a. The first pre-charge control switch 15a is switched to either connection to the power supply 9a by way of the line 17a or connection to the first pre-charge line 11a.

Similarly, one electrode of the second pre-charge capacitor 13b is connected to ground. The other electrode of the second pre-charge capacitor 13b is connected to either the line 17b or the second pre-charge line 11b by way of the second pre-charge control switch 15b. The second pre-charge control switch 15b is switched to either the power supply 9b by way of the line 17b or the second pre-charge line 11b.

Now, the operation of the display device 1 in this particular embodiment will be described. The description is focused herein primarily on the pre-charge operation. Generally, in the pre-charge operation prior to the pre-charge condition, the pre-charge control switches 15a, 15b connect the pre-charge capacitors 13a, 13b to the power supplies 9a, 9b, respectively. This enables the first pre-charge capacitor 13a to be charged by the power supply 9a by way of the first pre-charge control switch 15a, while charging the second pre-charge capacitor 13b by the power supply 9b by way of the second pre-charge control switch 15b.

Subsequently, in the pre-charge condition, the pre-charge control switches 15a, 15b connect the pre-charge capacitors 13a, 13b to the pre-charge lines 11a, 11b, respectively. Then, the pre-charge control switches 15a, 15b are connected to the plurality of source buses 3 by way of the switches SW1, SW2. Charges in the pre-charge capacitors 13a, 13b are supplied to the plurality of source buses 3 by way of the pre-charge control switches 15a, 15b, thereby setting the source bus voltage (the voltage on the source buses 3) to the pre-charge voltage.

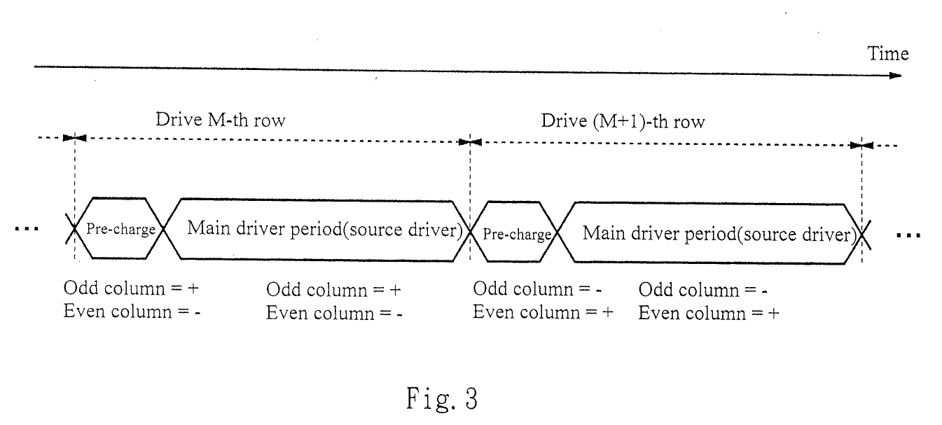

FIGS. 3, 4 and 5 show the aforementioned pre-charge operation in greater detail. Now, reference is made to FIG. 3. In this example, an M-th row and an (M+1)-th row are driven. The rows correspond to the gate lines that cross with the source buses 3. On the other hand, the source buses 3 correspond to the columns.

In driving each row, a pre-charge period is set prior to a main driving period by the source driver 5. The data signal is supplied to each source bus 3 from the source driver 5 in the main driving period, while pre-charging the source buses 3 in the pre-charge period.

The dot inversion driving is applied to the display device 1 in this particular embodiment. For performing the dot inversion driving, in the pre-charge period of the M-th row, the odd columns are pre-charged to positive, while pre-charging the even columns to negative. On the other hand, in the main driving period of the (M+1)-th row, the positive data signal is supplied to the odd columns and the negative data signal is supplied to the even columns.

In the subsequent (M+1)-th row, positive and negative are inverted. In other words, in the (M+1)-th row, the odd columns are pre-charged to negative and the even columns are pre-charged to positive in the pre-charge period. In the main driving period in the (M+1)-th row, the negative data signal is supplied to the odd columns and the positive data signal is supplied to the even columns.

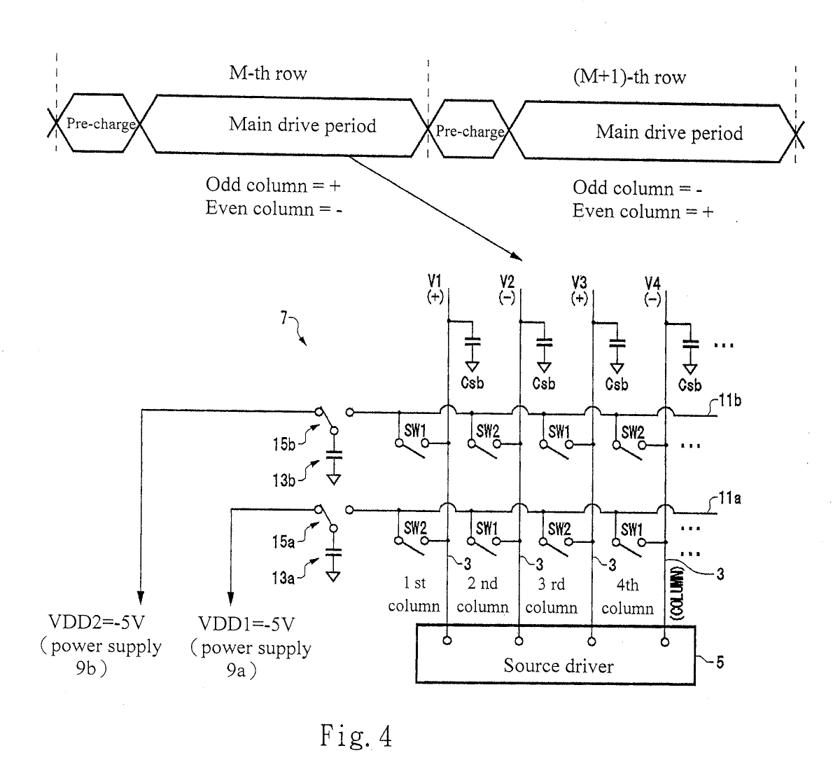

FIG. 4 shows the condition of the pre-charge circuit 7 in the main driving period for the M-th row in the example of FIG. 3. This corresponds to the condition prior to pre-charge. As shown in FIG. 4, the data signal is supplied to the plurality of source buses 3. For dot inversion driving, a positive voltage is applied to the odd columns and a negative voltage is applied to the even columns.

All of the switches SW1, SW2 are OFF in FIG. 4, thereby disconnecting the pre-charge lines 11a, 11b from the source buses 3.

The pre-charge control switches 15a, 15b connect the pre-charge capacitors 13a, 13b to the power supplies 9a, 9b. As a result, the first pre-charge capacitor 13a is charged by the power supply 9a, while the second pre-charge capacitor 13b is charged by the power supply 9b. The voltage on the first pre-charge capacitor 13a reaches the voltage VDD 1 (5V) of the power supply 9a and the voltage on the second pre-charge capacitor 13b reaches the voltage VDD 2 (−5V) of the power supply 9b.

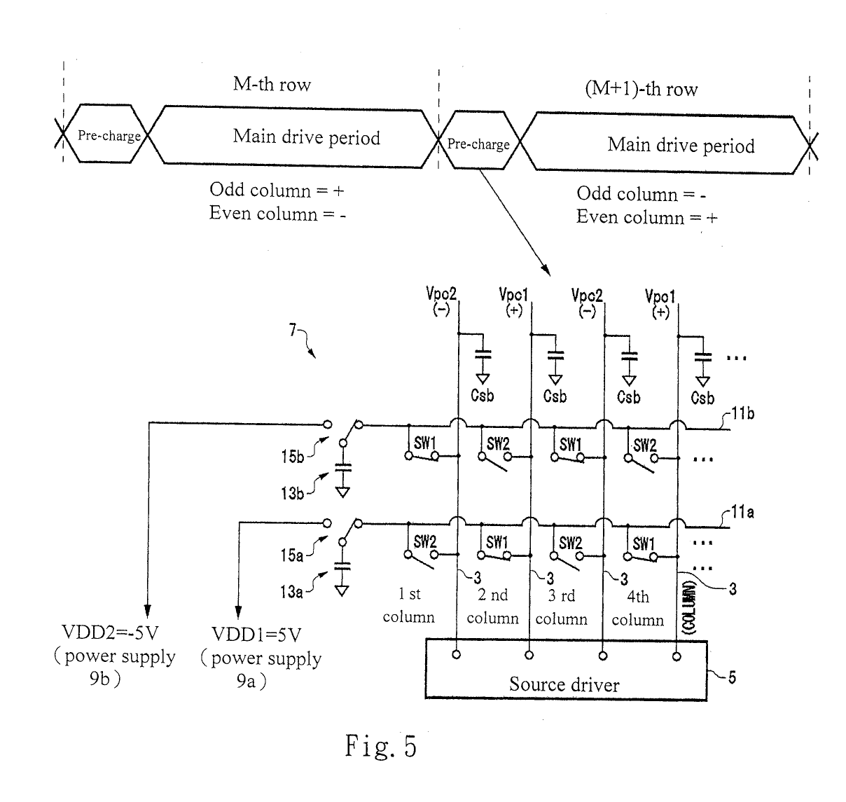

FIG. 5 shows the condition of the pre-charge circuit 7 in the pre-charge period for the (M+1)-th row in the example of FIG. 3. This corresponds to the pre-charge condition after charging the pre-charge capacitors 13a, 13b in FIG. 4. The pre-charge control switches 15a, 15b have been switched as shown in FIG. 5, i.e., the first pre-charge capacitor 13a is connected to the first pre-charge line 11a by the first pre-charge control switch 15a and the second pre-charge capacitor 13b is connected to the second pre-charge line 11b by the second pre-charge control switch 15b. In the pre-charge lines 11a, 11b, all of the first switches SW1 are ON, while all of the second switches SW2 are OFF.

With the aforementioned connection, the first pre-charge capacitor 13a is connected to the even column source buses 3 by way of the first pre-charge line 11a and the first switches SW1. Accordingly, the even column source buses 3 are positively charged and the voltage of these source buses becomes a pre-charge voltage Vpc1 (+). The second pre-charge capacitor 13b is connected to the odd column source buses 3 by way of the second pre-charge line 11b and the second switches SW2. Accordingly, the odd column source buses 3 are negatively charged and the voltage of the source buses becomes a pre-charge voltage Vpc2 (−).

In the above pre-charge, pre-charge sharing is carried out by the pre-charge capacitors 13a, 13b and the plurality of source buses 3. In case of FIG. 5, the total charges of the charge on the first pre-charge capacitor 13a and the residual charges of all of the even column source buses 3 are distributed to the first pre-charge capacitor 13a and the even column source buses 3. The residual charges are charges left after driving by the source driver 5. The distribution ratio is determined by the capacitance of the first pre-charge capacitor 13a and the capacitance of each source bus 3. As a result of the charge sharing, the even column voltage becomes the charge voltage Vpc1 (+) as shown in FIG. 5.

Similarly, the total charges of the charge on the second pre-charge capacitor 13b and the residual charges on the entire odd column source buses 3 are distributed to the second pre-charge capacitor 13b and the odd column source buses 3. The distribution ratio is determined by the capacitance of the second pre-charge capacitor 13b and the capacitance of each source bus 3. As a result of the charge sharing, the odd column voltage becomes the charge voltage Vpc2 (−) as shown in FIG. 5.

The pre-charge is performed in the above manner. In the above example, the first switches SW1 are ON and the second switches SW2 are OFF in the pre-charge period for the (M+1)-th row. In the pre-charge for the subsequent row, ON and OFF are inverted, i.e., the first switches SW1 are OFF and the second switches SW2 are ON. In this manner, ON and OFF of the switches SW1, SW2 are alternately switched at every row. Such switching changes plus/minus of the pre-charge voltage at every row and column for performing the pre-charge suitable for the dot inversion driving.

Now, a calculation will be made on the pre-charge voltages Vpc1, Vpc2 that derive from the aforementioned pre-charge operation. The pre-charge voltage Vpc1 will be calculated using the example in FIG. 5. The charges before and after pre-charge that is associated with the first pre-charge capacitor 13a is given by the following expression:

C1·VDD1+Csb·V2+Csb·V4+Csb·V6+ . . . Csb·Vn=(C1+n/2·Csb)·Vpc1

C1 is the capacitance of the first pre-charge capacitor 13a. VDD1 is the voltage of the power supply 9a. Csb is the capacitance of the source bus in each column (source bus 3). Vi is the voltage of the i-th column of the source bus prior to pre-charge driving. n is the number of columns of the display panel (the number of source buses).

In the above expression, the left side represents the total amount of charges before pre-charging. Specifically, it is the sum of the charge on the first pre-charge capacitor 13a and the charges on the even columns. In the example in FIG. 5, since the source buses 3 in the even columns are connected to the first pre-charge capacitor 13a, it is possible to calculate the charges on the even columns. On the other hand, the right side represents the total amount of charges after pre-charge.

It is assumed herein that V2=V4=V6= . . . =Vn=Va. In this case, the above expression can be modified and Vpc1 can be given by the following expression:

Vpc1=[C1/(C1+n/2·Csb)]·VDD1+[(n/2·Csb)/(C1+n/2·Csb)·Va

If it is assumed that C1=7.9 nF, Csb=10 pF, n=720, VDD=5V and Va=−3V, then Vpc1=2.496V.

Similarly, the pre-charge voltage Vpc2 can be calculated in the same manner. The amount of charges associated with the second pre-charge capacitor 13b before and after pre-charge can be given by the following expression:

C2·VDD2+Csb·V1+Csb·V3+Csb·V5+ . . . Csb·Vn−1=(C2+n/2·Csb)·Vpc2

C2 is the capacitance of the second pre-charge capacitor 13b. VDD2 is the voltage of the power supply 9b. Csb is the capacitance of the source buses in each column (source buses 3). Vi is the voltage of the i-th column of the source bus prior to pre-charging driving. n is the number of columns of the display panel (the number of source buses 3).

In the above expression, the left side represents the total amount of charges before pre-charge. Specifically, it is the sum of the charge on the first pre-charge capacitor 13a and the charges on the odd columns. Since the odd column source buses 3 are connected to the second pre-charge capacitor 13b in the example of FIG. 5, it is possible to calculate the charge on the odd columns. The right side represents the total amount of charges after pre-charge.

It is assumed herein that V1=V3=V5= . . . =Vn−1=Vb. In this case, the above expression can be modified and Vpc2 can be given by the following expression:

Vpc2=[C2/(C2+n/2·Csb)]·VDD2+[(n/2·Csb)/(C2+n/2·Csb)]·Vb

If it is assumed that C2=7.9 nF, Csb=10 pF, n=720, VDD2=−5V and Vb=3V, then Vpc2=−2.496V.

The pre-charge voltages Vpc1 and Vpc2 can be calculated in the above manner. In the above calculation, since charge sharing takes place, the pre-charge voltages Vpc1 and Vpc2 can be determined by the capacitances C1, C2 of the pre-charge capacitors 13a, 13b, the power supply voltages VDD1, VDD2 and the residual charges on the source buses 3 (and the residual charge can be determined by the source bus voltage and the source bus capacitance Csb).

By utilizing this, the capacitances C1, C2 of the pre-charge capacitors 13a, 13b are suitably set in this embodiment. For setting the capacitances C1, C2, target pre-charge voltages Vpc1, Vpc2 are set in advance. Then, the capacitances of the pre-charge capacitors 13a, 13b are calculated and suitably set such as C1=C2=7.9 nF like the above example. In this manner, the capacitances of the pre-charge capacitors 13a, 13b are set in this embodiment, thereby suitably obtaining the target pre-charge voltage.

It is to be noted in the above calculations that the voltage of each source bus 3 before pre-charge is uniformly set to Va, Vb and thus the residual charge on each source bus is assumed to be Va·Csb, Vb·Csb. It is preferable to use average values as Va, Vb.

Now, a second embodiment of the present invention will be described.

In the first embodiment that has been described hereinabove, it is assumed that the voltage of each source bus 3 is Va, Vb before pre-charge. However, the actual source bus voltage before pre-charge depends on the image to be displayed and thus not constant. And actual pre-charge voltages Vpc1, Vpc2 vary depending upon the magnitude of the source bus voltage. In this respect, the pre-charge voltage in the first embodiment is not accurately equal to the target value in the first embodiment.

In view of the above circumstance, the second embodiment takes the following construction and improves the accuracy of the pre-charge voltage. In the following descriptions, any description common to the first embodiment is abbreviated.

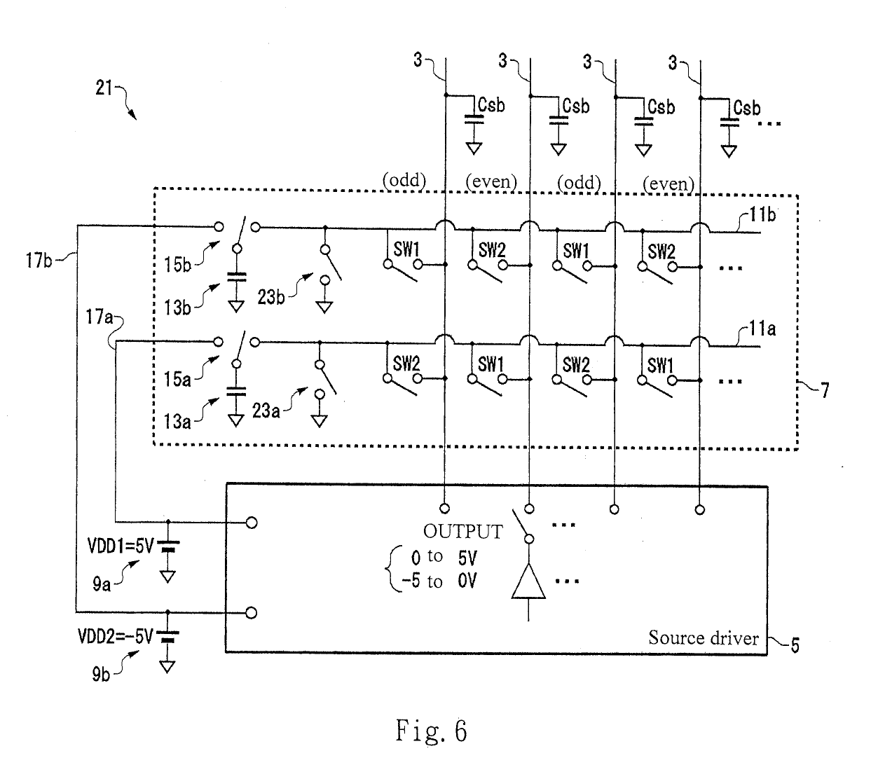

FIG. 6 shows a second embodiment of the display device 21. A difference from the display device 1 in FIG. 2 is that the display device 21 adds a first ground switch 23a a second ground switch 23b. These two additional switches are collectively referred to as the ground switches 23a, 23b.

One end of the first ground switch 23a is connected to the first pre-charge line 11a between the first pre-charge control switch 15a and the source buses 3. And the other end of the first ground switch 23a is connected to ground. This enables to connect the first pre-charge line 11a to ground when the first ground switch 23a is ON.

Similarly, one end of the second ground switch 23b is connected to the second pre-charge line 11b between the second pre-charge control switch 15b and the source buses 3. And the other end of the second ground switch 23b is connected to ground. This enables to connect the second pre-charge line 11b to ground when the second ground switch 23b is ON.

Now, the operation of the second embodiment of the display device 21 will be described. The display device 21 operates in the similar manner as the first embodiment of the display device 1.

However, it differs from the first embodiment in that the ground switches 23a, 23b connect the pre-charge lines 11a, 11b to ground before the pre-charge control switches 15a, 15b connect the pre-charge capacitors 13a, 13b to the pre-charge lines 11a, 11b, thereby setting the voltage of all of the source buses 3 to 0. Then, the ground switches 23a, 23b are turned OFF. Subsequently, the pre-charge control switches 15a, 15b connect the pre-charge capacitors 13a, 13b to the pre-charge lines 11a, 11b for pre-charging in the same way as in the first embodiment. Since the voltage of each source buses 3 before pre-charging is determined in this way, it is possible to improve accuracy of the pre-charge voltage.

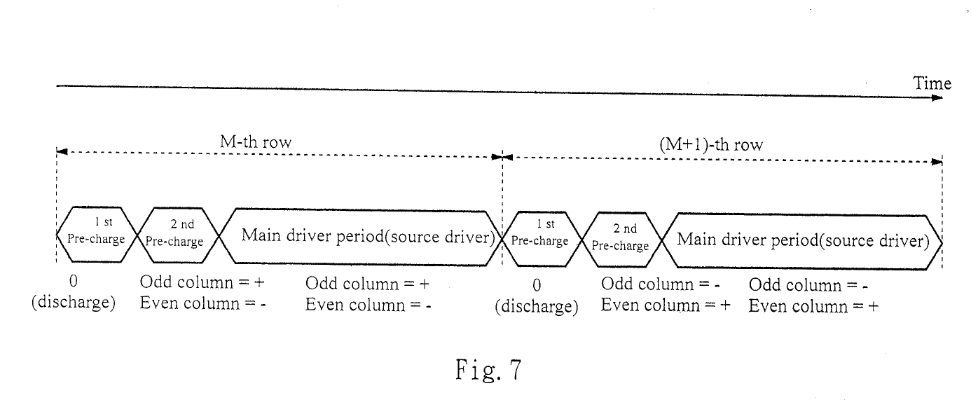

FIGS. 7-10 show the operation of the display device 21 in detail. Referring to FIG. 7, a first pre-charge period and a second pre-charge period are set as the pre-charge period in this embodiment.

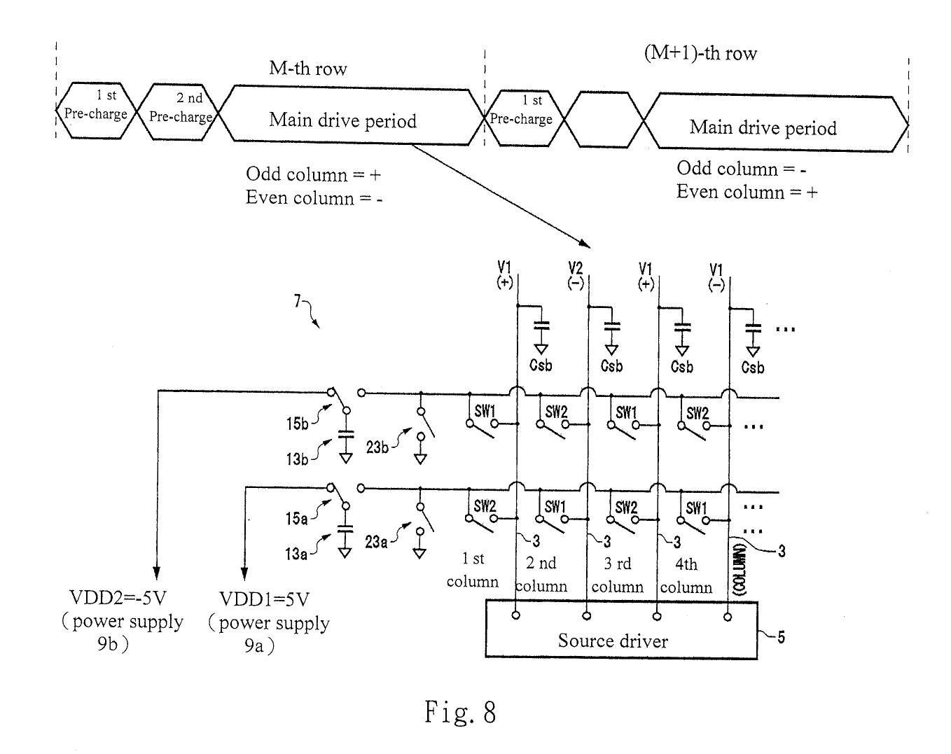

FIG. 8 shows the condition of the pre-charge circuit 7 in the main driving period for an m-th row. Each source bus 3 is driven by the source driver 5. The pre-charge capacitors 13a, 13b are connected to the power supplies 9a, 9b by way of the pre-charge control switches 15a, 15b for pre-charging. All of the switches SW1, SW2 are OFF and the ground switches 23a, 23b are also OFF.

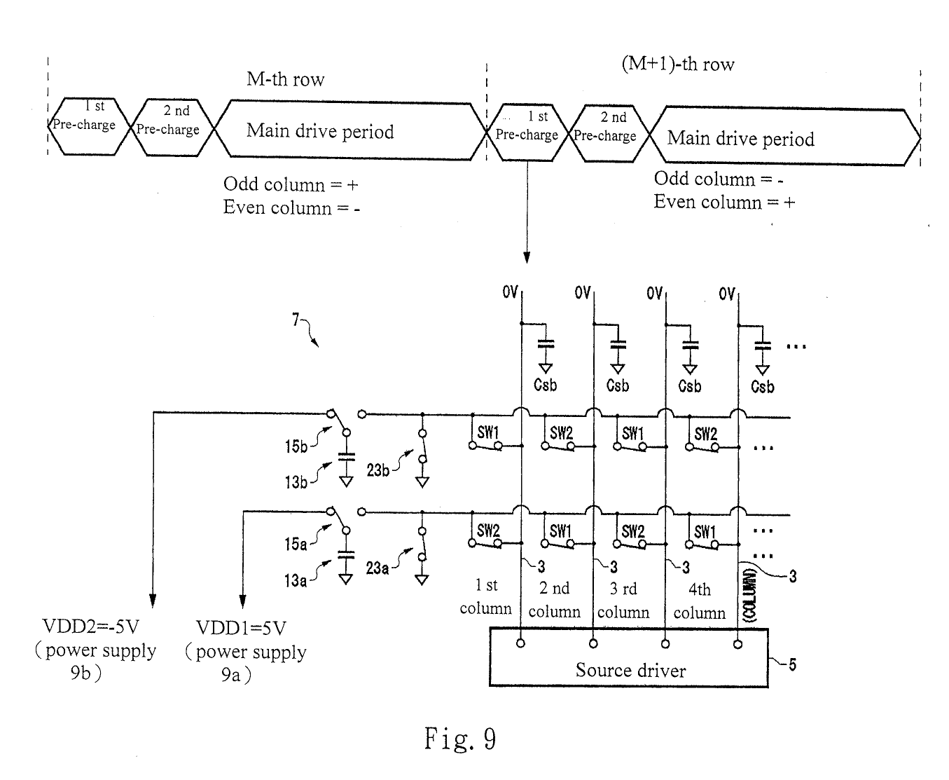

FIG. 9 shows the condition of the pre-charge circuit 7 in the first pre-charge period for an m+1-th row. At this stage, the pre-charge capacitors 13a, 13b are still connected to the power supplies 9a, 9b. The ground switches 23a, 23b are switched ON for connecting all of the source buses 3 to ground and setting the source bus voltage to 0.

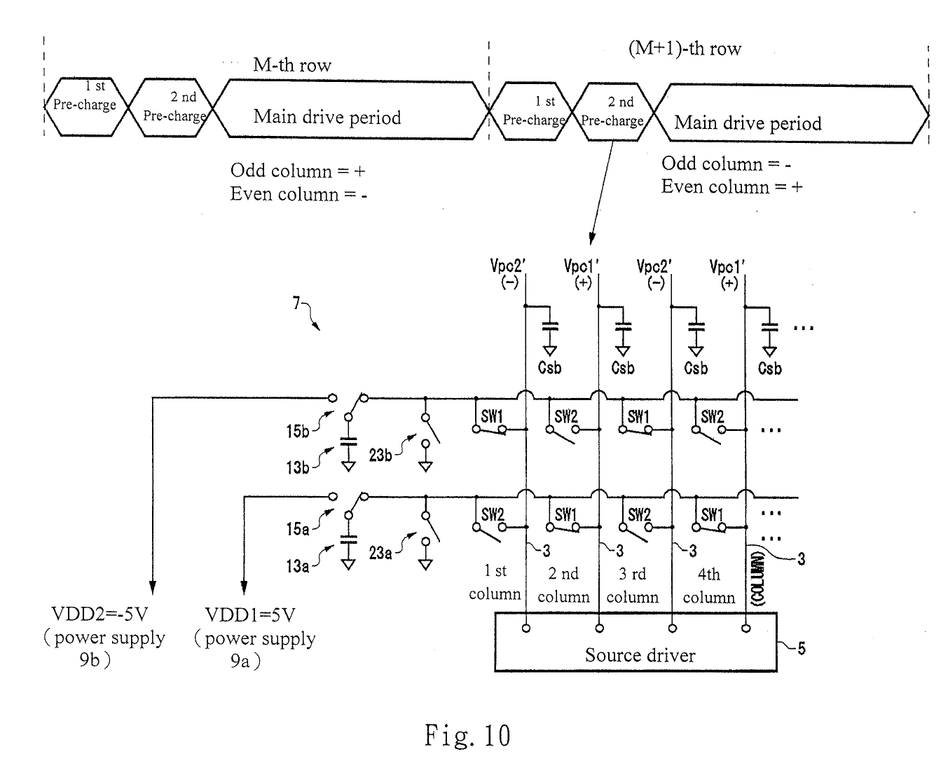

FIG. 10 shows the condition of the pre-charge circuit 7 in the second pre-charge period for the (m+1)-th row. The pre-charge capacitors 13a, 13b are connected to the pre-charge lines 11a, 11b by way of the pre-charge control switches 15a, 15b. The ground switches 23a, 23b are OFF, all of the first switches SW1 are ON and all of the second switches SW2 are OFF. Then, charges on the pre-charge capacitors 13a, 13b are moved to the source buses 3 for pre-charging. The source bus voltages become Vpc1′ (+), Vpc2′ (−) (Note that the pre-charge voltages in this embodiment are referred to as Vpc1′, Vpc2′ in order to distinguish them from those in the first embodiment).

Now, the pre-charge voltages Vpc1′, Vpc2′ that are derived from the above pre-charge operation will be calculated. The pre-charge voltage Vpc1′ will be calculated using the example as shown in FIG. 10. Charges before and after pre-charging associated with the first pre-charge capacitor 13a are given by the following expression:

C1·VDD1+Csb·0+Csb·0+Csb·0+ . . . Csb·0=(C1+n/2·Csb)·Vpc1′

C1 is the capacitance of the first pre-charge capacitor 13a. VDD1 is the voltage of the power supply 9a. n is the number of columns of the display panel (the number of source buses 3). As shown in the above expression, the source bus voltages Vi before pre-charge are all 0. This is because the source buses 3 are discharged by the first ground switch 23a in the first pre-charge period. The above expression can be modified and Vcp1′ can be given by the following expression:

Vpc1′=[C1/(C1+n/2·Csb)]·VDD1

It is assumed herein that C1=3.6 nF, Csb=10 pF, n=720 and VDD1=5V, then Vpc1′=2.500V.

The pre-charge voltage Vpc2′ can be calculated n the same way. The charge before and after pre-charge associated with the second pre-charge capacitor 13b is given by the following expression:

C2·VDD2+Csb·0+Csb·0+Csb·0+ . . . Csb0=(C2+n/2·Csb)·Vpc2′

C2 is the capacitance of the second pre-charge capacitor 13b. VDD2 is the voltage of the power supply 9b. n is the number of columns of the display panel (the number of source buses 3). Again, since the source buses 3 are discharged in the first pre-charge period, the source bus voltages Vi are all 0. The above expression can be modified and Vpc2′ is given by the following expression:

Vpc2′=[C2+(C2+n/2·Csb)]·VDD2

If it is assumed that C2=3.6 nF, Csb=10 pF, n=720 and VDD2=−5V, then Vpc2′=−2.500V.

As described hereinabove, the ground switches 23a, 23b are provided in this embodiment for discharging the source buses 3 prior to pre-charge. Accordingly, the pre-charge voltages Vpc1′, Vpc2′ are no longer depending upon the source bus voltage in response to the image that is displayed immediately before. This helps to improve accuracy of the pre-charge voltages Vpc1′, Vpc2′.

According to this embodiment, the source bus voltage is equal to ground (=0) prior to pre-charge. Pre-charge takes place from this voltage 0 as the starting point. As a result, the amount of charges required for charge sharing in the pre-charge can be reduced, thereby enabling to decrease the capacitance of the pre-charge capacitors 13a, 13b.

This aspect will be described in comparison with the first embodiment. In the first embodiment, the voltage of each source bus is opposite in polarity before and after pre-charge, thereby increasing voltage difference before and after pre-charge. This means that the amount of charges to be stored in the pre-charge capacitors 13a, 13b for pre-charge become large. On the contrary, in the second embodiment, since the source bus voltage prior to pre-charge is 0, the voltage difference of the source bus 3 before and after pre-charge is relatively small. As a result, the amount of charges to be stored in the pre-charge capacitors 13a, 13b can be small, thereby enabling to decrease the capacitance. If compared in the above example, the capacitance C1, C2 of the pre-charge capacitors 13a, 13b was 7.9 nF in the first embodiment, while the capacitance C1, C2 in the second embodiment decreases to 3.6 nF regardless of the fact that the conditions such as the source bus capacitance are the same.

The first and second embodiments of the present invention have been described hereinabove. According to these embodiments, provided is the pre-charge circuit that comprises pre-charge capacitors and the pre-charge control switch, the pre-charge capacitors are charged by utilizing the power supply of the source driver, and the charged pre-charge capacitors are used for pre-charging the plurality of source buses. In this way, it is possible to provide a display device having the pre-charge circuit that is simple in construction by eliminating the need for any additional pre-charge power supply.

Moreover, according to the second embodiment, the ground switches are provided for connecting the pre-charge lines to ground before the pre-charge control switches connects the pre-charge capacitors to the pre-charge lines. This improves accuracy of the pre-charge voltage as well as reducing the capacitance of the pre-charge capacitors.

Although the first and second embodiments are directed to the display devices, the present invention should not be restricted only to the display devices. Another embodiment of the present invention is, for example, a pre-charge circuit. A still another embodiment of the present invention is an electronic equipment or apparatus provided with such display device. And the electronic equipment may be one selected from a group of a mobile phone, a digital camera, a personal digital assistant (PDA), a notebook computer, a desktop computer, a television, a car media player, a portable video player, a GPS device, an avionics display or a digital photo frame.

Now, the most preferred embodiments of the present invention at the date of filing this application have been described hereinabove. However, it is to be noted that various modifications can be made on these embodiments without departing from the scope and spirit of the present invention. Accordingly such modifications should be included in the scope of the present invention.

The display device of the present invention is useful as a thin display device for a computer, a cellular phone, etc.

1. A display device comprising:
a plurality of source buses;
a source driver to be connected to the plurality of source buses;
at least one power supply for supplying electrical power to the plurality of source buses; and
a pre-charge circuit for pre-charging the plurality of source buses;
wherein the pre-charge circuit comprises at least one pre-charge line to be connected to the plurality of source buses at the time of pre-charging, at least one pre-charge capacitor, and at least one pre-charge control switch for alternately connecting the at least one pre-charge capacitor to the at least one of the power supply and at least one pre-charge line.

2. A display device of claim 1, wherein the at least one power supply has first and second power supplies for inversion driving, the pre-charge circuit comprises first and second pre-charge lines as the at least one pre-charge line, first and second pre-charge capacitors as the at least one pre-charge capacitor, and the first and second pre-charge control switches as the at least one pre-charge control switch, and the first and second pre-charge control switches alternately connecting the first and second pre-charge capacitors to the first and second power supplies to the first and second pre-charge lines.

3. A display device of claim 2, wherein a plurality of line switches are provided for alternately connecting the plurality of source buses to the first and second pre-charge lines at the time of pre-charging.

4. A display device of claim 2, wherein the capacitance of the first and second pre-charge capacitors is set based on the voltage of the power supply, the target pre-charge voltage and the residual charges of the plurality of source buses so that the source bus voltage of the plurality of source buses is equal to the target pre-charge voltage by performing charge sharing of the charges of the first and second pre-charge capacitors and the residual charges of the plurality of source buses by the first and second pre-charge capacitors and the plurality of source buses.

5. A display device of claim 2, further comprising first and second ground switches for connecting the first and second pre-charge lines to ground before the first and second pre-charge control switches connect the first and second pre-charge capacitors to the first and second pre-charge lines.

6. A pre-charge circuit provided in a display device having a plurality of source buses, a source driver to be connected to the plurality of source buses and at least one power supply for supplying electric power to the plurality of source buses for the purpose of pre-charging the plurality of source buses, comprising:
at least one pre-charge line to be connected to the plurality of source buses at the time of pre-charging;
at least one pre-charge capacitor; and
at least one pre-charge control switch for alternately connecting the at least one pre-charge capacitor to the at least one power supply and the at least one pre-charge line.

7. An electronic apparatus having the display device of claim 1 selected from a group of a mobile phone, a digital camera, a personal digital assistant (PDA), a notebook computer, a desktop computer, a television, a car media player, a portable video player, a GPS device, an avionics display or a digital photo frame.
